(19) United States
(12) Patent Application Publication
(10) Pub. No.: US 2020/0207176 A1
(43) Pub. Date: Jul. 2, 2020

(54) VEHICLE DYNAMIC DAMPING SYSTEM USING AIR SUSPENSION

(71) Applicant: Continental Automotive Systems, Inc., Auburn Hills, MI (US)

(72) Inventors: David Leigh Baker, Clarkston, MI (US); Heidi K. Hahn, Swartz Creek, MI (US); Jeremiah Thomas McClintock, Clawson, MI (US)

(73) Assignee: Continental Automotive Systems, Inc., Auburn Hills, MI (US)

(21) Appl. No.: 16/232,113

(22) Filed: Dec. 26, 2018

(51) Int. Cl. B60G 17/052; B60G 17/016; B60G 17/015; B60G 11/27

(52) U.S. Cl. CPC B60G 17/0525; B60G 17/0162; B60G 17/0164; B60G 17/0155; B60G 2400/40; B60G 2200/10; B60G 2400/0521; B60G 2400/0523; B60G 11/27

(57) ABSTRACT

A method dynamically stabilizes a vehicle having a suspension system including pneumatic air springs, with one air spring being associated with each wheel, each air spring being independently adjustable in height; an air spring valve associated with each air spring; and a reservoir containing a source of air. The method obtains data relating to at least lateral acceleration, yaw rate, roll rate, velocity and the steering wheel angle deviation of the vehicle. Thresholds are established, and the data is compared to the thresholds. If thresholds are exceeded, at least one air spring valve is automatically opened to increase air pressure in the associated air spring by receiving air from the reservoir, or to decrease air pressure in the associated air spring by returning air to the reservoir, so as to adjust a height of the associated air spring to help transfer the weight of the vehicle.

### FIELD

This invention relates to a vehicle suspension and, more particularly, to a dynamic damping system for a vehicle that employs an air suspension so that air pressure in one or more air springs can be adjusted to change the normal load applied to each wheel, to help control the wheel and/or vehicle dynamics.

### BACKGROUND

A vehicle uses stability features like electronic brake control systems to aid drivers by detecting and reducing the loss of traction. When the driver's intended input does not match the vehicle's direction, stability control will automatically apply the brakes or reduce engine torque to help direct the vehicle in the intended direction. As shown in FIG. 1A, when the vehicle 11 does not turn as sharply to a driver's adjustment of the steering wheel, this is referred to as understeer. As shown in FIG. 1B, when the vehicle 11 over rotates more than the driver intended, this is referred to as oversteer. During dynamic maneuvers where features such as electronic brake control aids are used, vehicles with an active suspension can utilize vehicle data to recognize when the vehicle is in a dynamic maneuver. The active suspension can compensate and add additional aid to provide the most stability possible prior to and/or during a dynamic maneuver.

There are current closed-loop electronic air suspension systems that allow for height adjustment of each wheel. An example is disclosed in U.S. Patent Application Publication No. 20170158016 A1. This system includes an air spring/strut mounted at each wheel that are individually adjustable in height to provide optimized traction for the vehicle. The system can only be automatically activated if the vehicle is stopped or is moving very slowly (3-5 mph) in fear of inducing more instability.

Thus, there is a need to provide a suspension system for vehicle that, based on data provided by a plurality of sensors detecting how the vehicle is handling a driver's dynamic maneuver, can automatically increase or decrease pressure in air springs to adjust the spring height. This adjusted height may result in changes in normal loads applied to each wheel.

### SUMMARY

An objective of the invention is to fulfill the need referred to above. In accordance with the principles of an embodiment, this objective is achieved by a vehicle system including a suspension system supported by a frame or unibody and having a plurality of pneumatic air springs, with one air spring being associated with each wheel of the vehicle. Each air spring is being independently adjustable in height. An air spring valve and a height sensor is associated with each air spring. A reservoir contains a source of air. At least one reservoir valve is associated with the reservoir. Supply lines fluidly connect the reservoir with the air spring valve of each air spring. A plurality of sensors is constructed and arranged to obtain data relating to at least yaw acceleration, yaw acceleration rate, lateral acceleration, lateral acceleration rate, longitudinal acceleration, vehicle speed, vehicle roll, vehicle roll rate, steering wheel angle, and steering wheel rate. An electronic control unit (ECU) has a processor circuit. The ECU is constructed and arranged to receive signals from the height sensors and from the plurality of sensors. The ECU stores entry thresholds for each of lateral acceleration, yaw rate, roll rate and the steering wheel angle deviation. The ECU is constructed and arranged to determine if any entry thresholds are exceeded during a dynamic maneuver by a driver of the vehicle and, if an entry threshold is exceeded, the ECU is constructed and arranged to automatically open at least one reservoir valve and at least one of the air spring valves to increase or decrease air pressure at the associated air spring so as to adjust a height thereof until the threshold is no longer exceeded.

In accordance with another aspect of an embodiment, a method stabilizes a vehicle having a suspension system including a plurality of pneumatic air springs, with one air spring being associated with each wheel of the vehicle. Each air spring is independently adjustable in height. An air spring valve is associated with each air spring. A reservoir contains a source of air. The method obtains, with a plurality of sensors, data relating to at least lateral acceleration, yaw rate, roll rate and the steering wheel angle deviation of the vehicle. Entry thresholds are established. In a processor circuit, the data is compared to the entry thresholds. If an entry threshold is exceeded during a dynamic maneuver by a driver of the vehicle, at least one of the air spring valves is automatically opened to increase air pressure in the associated air spring by receiving air from the reservoir, or to decrease air pressure in the associated air spring by returning air to the reservoir, so as to adjust a height of the associated air spring until the entry threshold is no longer exceeded.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1A is a schematic illustration of a conventional vehicle experiencing an understeer condition.

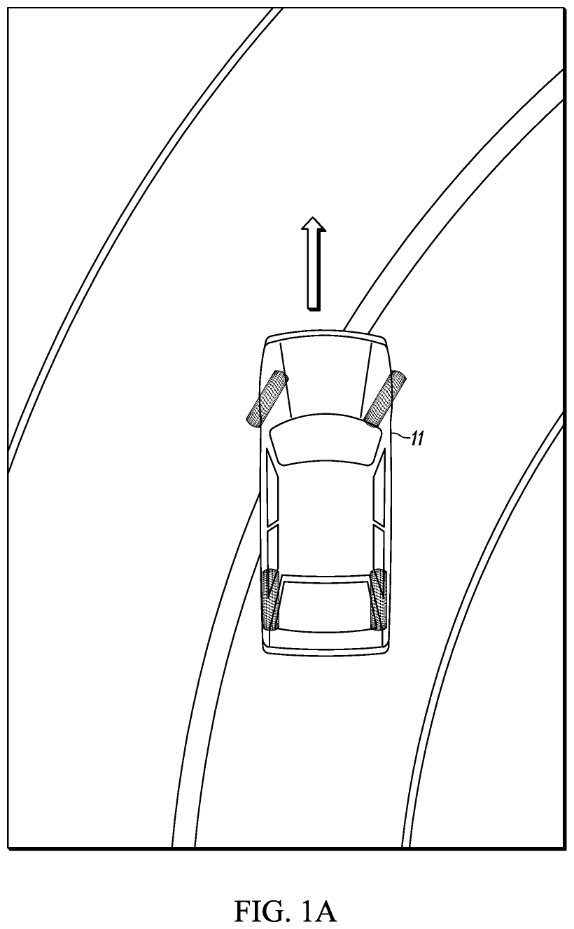

FIG. 1B is a schematic illustration of a conventional vehicle experiencing an oversteer condition.

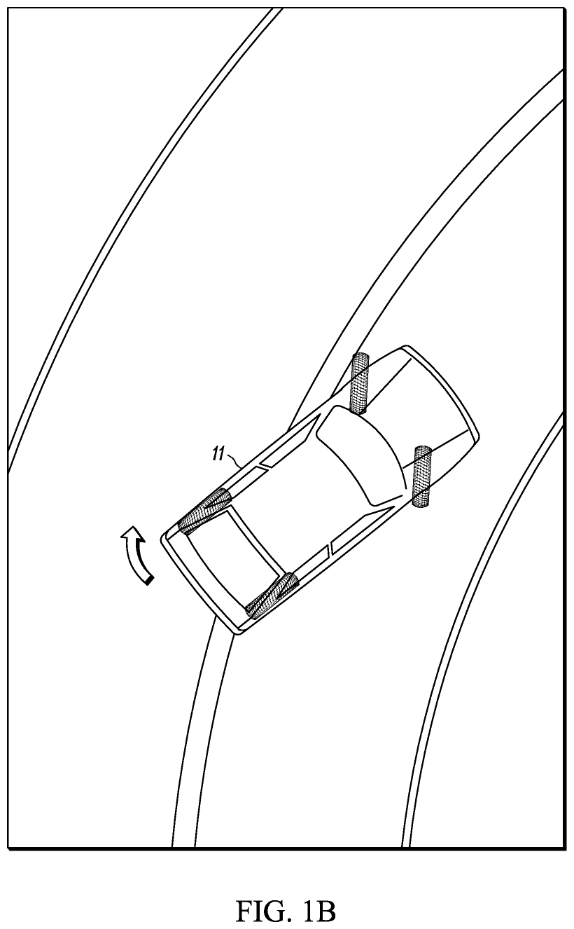

FIG. 2 is a schematic illustration of a frame for the vehicle having an air suspension system in accordance with and embodiment of the invention.

FIG. 3 is a schematic view of a portion of the air suspension system of an embodiment and an electronic power steering system each being coupled to a vehicle network bus.

### DETAILED DESCRIPTION OF EXEMPLARY EMBODIMENTS

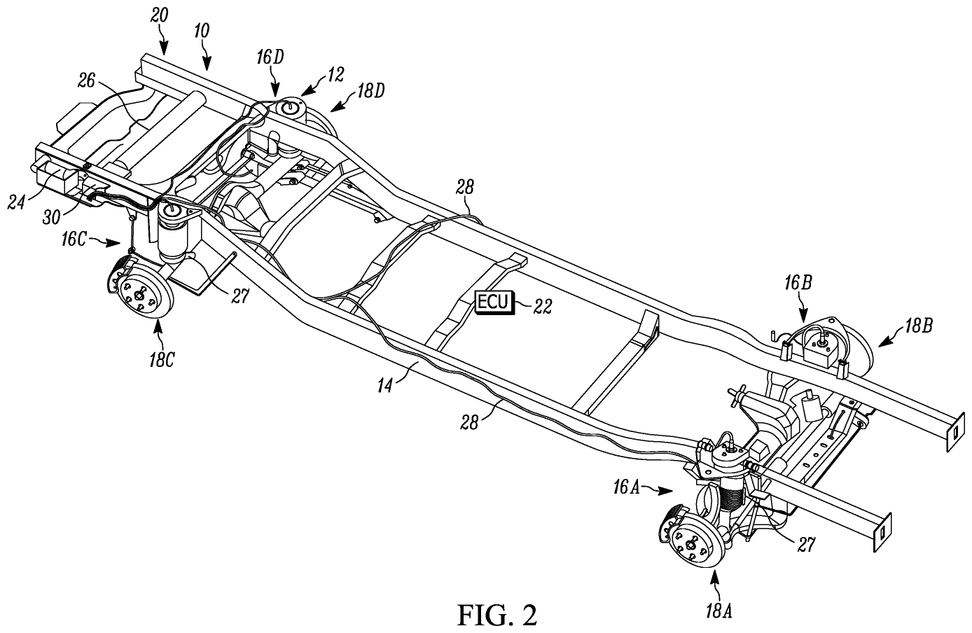

The following description is merely exemplary in nature and is in no way intended to limit the disclosure, its application, or uses. For purposes of clarity, the same reference numbers will be used in the drawings to identify similar elements. FIG. 2 illustrates a vehicles suspension 10 having an air suspension system 12 in accordance with an embodiment. The air suspension system 12 is supported by a frame or unibody 14. The air suspension system 12 has pneumatic air springs 16A-D, with one air spring being located at each of the wheel 18 locations on the suspension 10. The four air springs 16A-D are independently adjustable in height as will be explained more fully below. Two of the air springs 16A, B are located at the front wheels 18A, B and the other two air springs 16C, D are located at the rear wheels 18C, D.

The air suspension system 12 includes an air supply unit 20 fluidly connected to the air springs 16A-D. The air supply unit 20 includes an air suspension electronic control unit (ECU) 22, a compressor 24, a reservoir 26 and valve structure 30. The individual components of the air supply unit may be assembled together or supported on the vehicle at separate locations. In the embodiment shown, the ECU 22 is located remote from the compressor 24, reservoir 26 and reservoir valve structure 30 (electrical connections not shown in FIG. 2). Each air spring 16A-D has a ride height sensor 27 that measures the distance between the road and a particular point on the vehicle's suspension, chassis or body.

The air supply unit 20 is fluidly connected to the four air springs 16A-D through supply lines 28. In the embodiment shown, the air suspension system 12 is a closed system. The valve structure 30 is controlled by the ECU 22 to regulate the air supply between the compressor 24, the reservoir 26 and the air springs 16A-D. The compressor 24 and/or the reservoir 26 can be considered the source of air for the system 12. The valve structure 30 may be a single unit defining multiple valves, multiple valves located together, or multiple valves at different locations. Preferably the valves of the valve structure 30 are solenoid valves. Additionally, the reservoir 26 may be a single or multiple tank assembly.

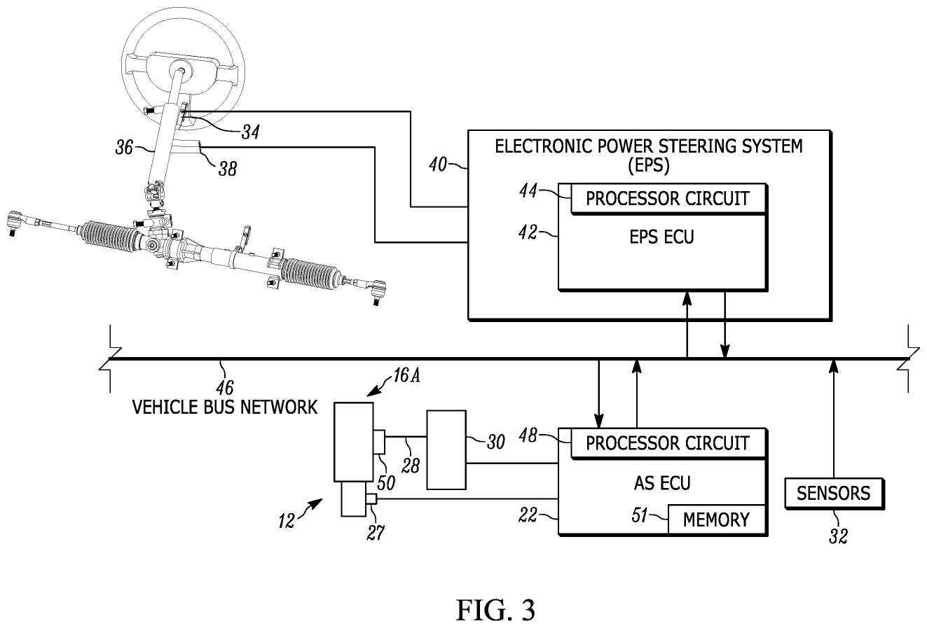

The air springs 16A-D are adjustable in height to accommodate various driving conditions based on data from a plurality of sensors 32 (FIG. 3) that communicate with the ECU 22 preferably via a network bus 46 of the vehicle, or the data is calculated within the ECU 22, or directly communicated from another ECU. The sensors 32 detect how the vehicle is handling the driver's input based on the current height of the air springs. With reference to FIG. 3, the sensors 32 can be mounted on the vehicle to obtain data that includes, but is not limited to, yaw acceleration, yaw acceleration rate, lateral acceleration, lateral acceleration rate, longitudinal acceleration, vehicle speed, vehicle state (oversteer/understeer), vehicle roll/roll rate and the wheel height. Also, the data obtained preferably includes steering wheel angle obtained from sensor 34 mounted on steering wheel 36 and steering wheel rate from sensor 38 which communicate with the power electronic power steering system 40. System 40 includes an ECU 42 having a processor circuit 44. Each ECU 42 and ECU 22 communicates with the vehicle network bus 46 such as a CAN bus. The suspension system 12 can utilize sensors to provide system pressure and ride heights if so equipped. The ECU 22 can also calculate, in processor circuit 48, a surface mu based on the signals that the ECU 22 receives. It is noted that the sensors 32 can communicate directly with ECU 22 if desired.

Tunable entry thresholds are provided in memory 51 of the ECU 22 for lateral acceleration (LAT), yaw rate, roll rate, vehicle velocity and the steering wheel angle (SWA) deviation. The steering deviation is the intended path of the vehicle versus the actual steering path of the vehicle. Software, executed by the processor circuit 48 determines if the vehicle is oversteering or understeering, what velocity the vehicle is traveling and determines the calculated surface mu, which are factors that are used to establish the thresholds. Once the software has detected that an entry threshold has been exceeded and the entry conditions are met, the ECU 22 will request the appropriate damper and a target ride height for the vehicle.

The ECU 22 constantly looks to the ride height sensor 27 of each wheel and the processor circuit 48 determines if an increase or decrease of pressure is required to control the air spring to be at a desired height. When adjustment of one or more air springs is needed, the ECU 22 will send an electrical signal to cause a valve of the valve structure 30 to automatically open to fluidly communicate with the reservoir 26. Also, an electrical signal sent by the ECU 22 will open an air spring valve 50 (e.g., a solenoid valve) of an associated air spring A, B, C, or D or a combination of these air springs, to transfer air pressure to the air spring(s) or reduce air pressure therefrom, to achieve the desired pressure at a tunable rate, depending on vehicle velocity. For instance, at higher speeds the change in pressure in the air spring needs to be quick. The pressure increase/decrease can be estimated by the pressure delta and the height sensor measurement. If required, the ECU 22 will activate the compressor 24 to fill the reservoir 26 in the event air needs to be transferred faster. The software utilizes a closed loop code to maintain the requested pressure during the dynamic event. Once the vehicle no longer exceeds a threshold, the ECU 22 will return the air springs to a desired pressure and thus to a desired height.

Thus, adjustment of pressure to an air spring adjusts the spring height. This adjusted height may result in changes in normal loads applied to each wheel. Changes in wheel normal loads change wheel traction (slip) and vehicle dynamics (pitch, roll, yaw displacement, rate and acceleration) to help stabilize the vehicle during a dynamic driving situation.

When lowering any of the air springs 16A-D, the excess air is sent to the reservoir 26 for storage. When raising any of the air springs 16A-D, the required air is sent from the reservoir 26 to the appropriate air spring. The compressor 24 ensures that the air pressure within the system 12 is maintained at the desired level. The closed loop system maintains system air mass and is able to move air through the system much quicker than open loop systems. Open systems need to take air in and reduce humidity before introducing the air to the springs. The closed loop system of the embodiment uses the reservoir 26 to help stored dry air to move quickly into the system if needed.

In the embodiment, the software is executed in the ECU 22 of the air suspension system. However, the software can be executed in any ECU of the vehicle that is coupled to the bus 46.

Thus, with the air suspension system 12, when a dynamic maneuver is induced by the driver causing the vehicle to become unstable, based on input from the sensors 32, 34 and 38, the system 12 can automatically increase or decrease pressure in the air spring on a wheel to help transfer vehicle weight and increase the contact point of the wheel to help stabilize the vehicle without driver assistance. Due to newer technology, the system 12 allows for more intelligent and quicker decision on ride height of the vehicle as well as at each wheel. Thus, the air suspension system 12 adjusts the height quickly and can help the driver in a dynamic maneuver (e.g. at street legal speeds) instead of hindering.

The operations and algorithms described herein can be implemented as executable code within the micro-controller or ECU 22 having processor circuit 48 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a micro-processor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 51 can be implemented, for example, using a non-volatile memory such as a programmable read only memory (PROM) or an EPROM, and/or a volatile memory such as a DRAM, etc.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A vehicle system comprising:
a suspension system supported by a frame and including a plurality of pneumatic air springs, with one air spring being associated with each wheel of the vehicle, each air spring being independently adjustable in height,
an air spring valve associated with each air spring,
a height sensor associated with each air spring,
a reservoir containing a source of air,
at least one reservoir valve associated with the reservoir,
supply lines fluidly connecting the reservoir with the air spring valve of each air spring,
a plurality of sensors constructed and arranged to obtain data relating to yaw acceleration, yaw acceleration rate, lateral acceleration, lateral acceleration rate, longitudinal acceleration, vehicle speed, vehicle roll, vehicle roll rate, steering wheel angle, and steering wheel rate, and
an electronic control unit (ECU) having a processor circuit, the ECU being constructed and arranged to receive signals from the height sensors and from the plurality of sensors, the ECU storing entry thresholds for each of at least lateral acceleration, yaw rate, roll rate, vehicle velocity and the steering wheel angle deviation,
wherein the ECU is constructed and arranged to determine if an entry threshold is exceeded during a dynamic maneuver by a driver of the vehicle and, if an entry threshold is exceeded, the ECU is constructed and arranged to automatically open at least one reservoir valve and at least one of the air spring valves to increase or decrease air pressure at the associated air spring so as to adjust a height thereof until the entry threshold is no longer exceeded.

2. The system of claim 1, wherein each reservoir valve and each air spring valve is a solenoid valve.

3. The system of claim 1, wherein the ECU is part of the suspension system.

4. The system of claim 1, wherein the sensors include a steering wheel angle sensor, steering wheel rate sensor, wheel speed sensors, lateral, yaw, pitch and roll sensors.

5. The system of claim 4, wherein the plurality of sensors is in communication with the ECU via a network bus.

6. The system of claim 1, further comprising a compressor constructed and arranged to maintain air pressure in the reservoir at a desired level.

7. The system of claim 1, wherein the processor circuit is constructed and arranged, based on the data obtained by the plurality of sensors, to determine an oversteer or understeer state of the vehicle which is utilized as a factor in establishing at least one of the thresholds.

8. The system of claim 1, wherein the processor circuit is constructed and arranged, based on the data obtained by the plurality of sensors, to calculate surface mu which is utilized as a factor in establishing at least one of the thresholds.

9. A method of dynamically stabilizing a vehicle having a suspension system including a plurality of pneumatic air springs, with one air spring being associated with each wheel of the vehicle, each air spring being independently adjustable in height; an air spring valve associated with each air spring; and a reservoir containing a source of air, the method comprising the steps of:
obtaining, with a plurality of sensors, data relating to at least lateral acceleration, yaw rate, roll rate and the steering wheel angle deviation of the vehicle,
establishing entry thresholds,
comparing, in a processor circuit, the data to the entry thresholds, and
if an entry threshold is exceeded during a dynamic maneuver by a driver of the vehicle, automatically opening at least one of the air spring valves to increase air pressure in the associated air spring by receiving air from the reservoir, or to decrease air pressure in the associated air spring by returning air to the reservoir, so as to adjust a height of the associated air spring until the entry threshold is no longer exceeded.

10. The method of claim 9, wherein the plurality of sensors include a steering wheel angle sensor, steering wheel rate sensor, wheel speed sensors, lateral, yaw, and pitch and roll sensors.

11. The method of claim 9, wherein the suspension system further includes a compressor fluidly connected with the reservoir, the method further comprises maintaining air pressure in the reservoir at a desired level by activating the compressor.

12. The method of claim 9, wherein the step of establishing thresholds includes determining an oversteer or understeer state of the vehicle.

13. The method of claim 9, wherein the step of establishing thresholds includes calculating surface mu.

14. The method of claim 9, wherein the air spring valves are solenoid valves and the step of opening at least one of the air spring valves includes sending an electrical signal thereto.

15. The method of claim 9, wherein the plurality of sensors further obtain data relating to lateral acceleration rate, longitudinal acceleration, vehicle speed, vehicle roll, and steering wheel rate.

16. The method of claim 9, wherein the step of automatically opening at least one of the air spring valves occurs while the vehicle is at street legal speed.
